(19) United States
(12) Patent Application Publication
(10) Pub. No.: US 2006/0003113 A1
(43) Pub. Date: Jan. 5, 2006

(54) Ink jet recording medium and method for producing the same

(75) Inventors: Ryoichi Nakano, Shizuoka-ken (JP); Kozo Nagata, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/128,430

(22) Filed: May 13, 2005

(30) Foreign Application Priority Data
May 13, 2004 (JP) 2004-143530
Aug. 16, 2004 (JP) 2004-236721

(51) Int. Cl. B41M 5/00

(52) U.S. Cl. 428/32.24

(57) ABSTRACT

A method for producing an ink jet recording medium, in which an ink receiving layer is formed on a support. The formation of the ink receiving layer includes: coating the support with a first liquid containing a water-soluble resin, a cross-linking agent and a first metal compound, to form a coating layer on the support; and applying, to the coating layer, a second liquid containing a second metal compound (1) at the same time as the coating of the first liquid, or (2) before the coating layer formed by coating the first liquid exhibits a decreasing rate of drying during drying of the coating layer, to harden the coating layer by cross-linking.

### CROSS-REFERENCE TO RELATED APPLICATION

This application claims priority under 35 USC 119 from Japanese Patent Application Nos. 2004-143530 and 2004-236721, the disclosures of which are incorporated by reference herein.

### BACKGROUND OF THE INVENTION

1. Field of the Invention

The present invention relates to a material for recording, which is suitable for ink jet recording using liquid ink such as aqueous ink or oily ink, or solid ink which is a solid at ambient temperature and which is used for printing after it is molten and liquefied, and particularly to an ink jet recording medium having excellent ink receiving ability, and a method for producing the same.

2. Description of the Related Art

Recently, various information processing systems have been developed along with rapid development in the information industry. Recording methods and devices suitable for these information processing systems have also been developed and variously put to practical use.

Among the above-mentioned recording methods, the ink jet recording method can be used to record on many kinds of recording materials, and hardware (a device) therefor is comparatively low-priced, compact and very quiet. Therefore, the ink jet recording method has been widely used in the office as well as at home.

Along with the recent achievement of high resolution ink jet printers, it has become possible to obtain so-called “photograph-like” high-quality recorded products. Further, along with the development of hardware (devices), various recording sheets for ink jet recording have been developed.

Examples of the properties required for a recording sheet for ink jet recording include (1) quick drying (high ink absorption speed), (2) ink dots having proper and uniform diameters (no bleeding), (3) excellent granularity, (4) high circularity of dots, (5) high color density, (6) high saturation (no dullness), (7) excellent light fastness, gas resistance and water resistance at printed portions, (8) a recording sheet having a high degree of whiteness, (9) excellent storability of a recording sheet (no yellow discoloration or image bleeding during long term storage), (10) resistance to deformation and excellent dimensional stability (sufficiently small curl), and (11) excellent running properties in hardware. Further, in addition to the above-mentioned properties, glossiness, surface smoothness and texture similar to that of a silver salt photograph are required for use as photographic glossy paper used to obtain a photograph-like high-quality recorded product.

As ink jet recording sheets which satisfy the above-mentioned requirements, those in which a color-material receiving layer is formed by coating a support with a liquid containing inorganic fine particles, a mordant, a water-soluble resin such as PVA, and a hardening agent for hardening the water-soluble resin (for example, see Japanese Patent Application Laid-Open (JP-A) No. 2000-211235, paragraphs [0055] to [0057]), and those in which a color-material receiving layer is formed by coating a support with a liquid containing inorganic fine particles, a metal compound, and a water-soluble resin such as PVA, and prior to complete drying of the coating layer, applying a hardening agent for hardening the water-soluble resin to the coating layer (for example, see JP-A No. 2001-334742) are known.

The color-material receiving layer used in an ink jet recording sheet, which is described in the above-mentioned JP-A No. 2000-211235 (paragraphs [0055] to [0057]), is obtained by applying a coating liquid that contains fumed silica, a cationic polymer having a constitutional unit of a polydiallylamine derivative (dimethyl diallyl ammonium chloride polymer), PVA and boric acid, and by drying the coating liquid. However, the ink jet recording sheet thus obtained provides a low printing density of an image and has a low degree of glossiness.

The ink receiving layer (a color-material receiving layer) used in an ink jet recording sheet, which is described in the above-mentioned JP-A No. 2001-334742, is obtained by coating a support with a coating liquid containing inorganic fine particles (for example, fumed silica having the average primary particle size of 20 nm or less), a water-soluble resin (for example, PVA), and a bivalent or higher valency water-soluble metal salt, and at the same time as the coating or before the coating layer exhibits a decreasing rate of drying, applying a solution containing a cross-linking agent that allows cross-linking of the water-soluble resin (for example, borax or boric acid) to harden the coating layer. The ink receiving layer thus obtained can prevent occurrence of cracks, but there exist problems in that the printing density of an image is low and the liquid stability of the coating liquid containing the water-soluble metal salt is not sufficient.

As a mordant which is used to fix a dye in an ink receiving layer, an inorganic mordant such as a polyvalent metal salt is known in addition to a cationic polymer such as described in the above-mentioned JP-A No. 2000-211235 (paragraphs [0055] to [0057]). Examples of the inorganic mordant include those described in JP-A Nos. 2002-172850, 2002-192830 and 2002-274013).

The ink receiving layer described in the above-mentioned JP-A No. 2002-172850 contains inorganic fine particles, polyvinyl alcohol, at least two types of cationic polymers having a quaternary ammonium group, and a compound having a zirconium or aluminum atom in its molecule (other than zirconium oxide and aluminum oxide), thereby allowing improvement in resistance to bleeding and water resistance of a water-soluble dye during preservation after printing without increase in bronzing.

Further, the ink receiving layer described in the above-mentioned JP-A No. 2002-192830 contains polyvinyl alcohol, a cationic polymer, and a compound having a zirconium or aluminum atom (other than zirconium oxide and aluminum oxide), and the film surface of the ink receiving layer after printing by an ink jet printer has a pH of 4 to 6. The ink receiving layer thus obtained provides improvement in resistance to bleeding and water resistance of a water-soluble dye during preservation after printing without increase in bronzing.

Moreover, the color-material receiving layer described in the above-mentioned JP-A No. 2002-274013 contains inorganic fine particles, a hydrophilic binder, a compound A having a zirconium or aluminum atom in its molecule (other than zirconium oxide and aluminum oxide), and a compound B, which is different from the compound A and contains a polyvalent metal atom in its molecule, in the amount of 0.1 to 10% by mol relative to the amount of the compound A. The color-material receiving layer thus obtained prevents occurrence of bleeding of a printed image formed using a water-soluble dye, at the time of preservation, without increase bronzing, and also provides improvement in the water resistance of an image.

When the ink receiving layer is formed using the inorganic mordants described in the above-mentioned JP-A Nos. 2002-172850, 2002-192830 and 2002-274013, in the same manner as in the above-mentioned JP-A No. 2001-334742, no cracks are formed in the ink receiving layer, but there exists a problem in that sufficient glossiness or a high printing density cannot be obtained.

### SUMMARY OF THE INVENTION

In view of the above-described circumstances, the present invention provides an ink jet recording medium in which excellent printing density and glossiness of an image is obtained and image bleeding over time is reduced, and a method for producing the same.

A first aspect of the present invention is to provide a method for producing an ink jet recording medium, in which an ink receiving layer is formed on a support, wherein the forming of the ink receiving layer comprises: coating the support with a first liquid containing a water-soluble resin, a cross-linking agent and a first metal compound, to form a coating layer on the support; and applying, to the coating layer, a second liquid containing a second metal compound (1) at the same time as the coating of the first liquid, or (2) before the coating layer formed by coating the first liquid exhibits a decreasing rate of drying during drying of the coating layer, to harden the coating layer by cross-linking.

A second aspect of the present invention is to provide an ink jet recording medium produced by the method of the first aspect, wherein all types of metal compounds in the ink receiving layer are distributed more extensively in a direction away from the support.

A third aspect of the present invention is to provide an ink jet recording medium produced by the method of the first aspect, wherein a ratio of concentration of all types of metal compounds in the ink receiving layer satisfies the following expression:
0.8<C1/C2<1.0
wherein C1 and C2 respectively represent a relative concentration of the metal compounds in a layer that contacts the support and in a layer that does not contact the support when the ink receiving layer is divided into two equal parts by a cross section parallel to the support.

### DETAILED DESCRIPTION OF THE INVENTION

[Method for Producing Ink Jet Recording Medium]

The method for producing an ink jet recording medium according to the present invention is a method that comprises forming an ink receiving layer on a support, in which the forming of the ink receiving layer includes at least the following steps (A) and (B).

Step (A) is a step in which a first liquid containing a water-soluble resin, a cross-linking agent and a first metal compound is coated onto the support to form a coating layer. Step (B) is a step in which a second liquid containing a second metal compound is applied to the above-mentioned coating layer (1) at the same time as the coating of the first liquid, or (2) before the coating layer formed by coating the first liquid exhibits a decreasing rate of drying during drying of the coating layer, to harden the coating layer by cross-linking.

Next, the method for producing an ink jet recording medium according to the present invention will be described in detail.

The method for producing an ink jet recording medium according to the present invention is a method (wet-on-wet (WOW) method) which comprises: a step in which the first liquid containing a water-soluble resin, a cross-linking agent, and a first metal compound (occasionally hereinafter referred to as “coating liquid for an ink receiving layer”) is coated onto a support to form a coating layer (step (A): coating step); and a step in which the second liquid containing a second metal compound (occasionally hereinafter referred to as “basic solution”) is applied to the above-mentioned coating layer (1) at the same time as the coating of the first liquid, or (2) before the coating layer formed by coating the first liquid exhibits a decreasing rate of drying during drying of the coating layer, to harden the coating layer by cross-linking (step (B): hardening step). In this method, due to the hardening of the coating layer, which was formed on the support in the step (A), by cross-linking in the step (B), the ink receiving layer is formed in which the coating layer is hardened by cross-linking.

In the present invention, by providing, in advance, the coating layer formed by the first liquid containing the first metal compound, and further applying, to the coating layer, the second liquid containing the second metal compound, an excellent film forming property that allows sufficient film hardening is obtained, and the first metal compound and the second metal compound (and other mordant components) act as mordants, whereby an ink (particularly, a dye) is sufficiently mordanted. As a result, an ink jet recording medium is obtained in which a high printing density of an image and excellent glossiness are obtained and bleeding of an image over time is reduced.

The first metal compound contained in the first liquid is preferably an acidic metal compound, and examples of the first metal compound include a polyvalent water-soluble metal salt and a hydrophobic metal salt compound. Specific examples of the first metal compound include a salt or complex of metal selected from a group consisting of magnesium, aluminum, calcium, scandium, titanium, vanadium, manganese, iron, nickel, zirconium, copper, zinc, gallium, germanium, strontium, yttrium, molybdenum, indium, barium, lanthanum, cerium, praseodymium, neodymium, samarium, europium, gadolinium, dysprosium, erbium, ytterbium, hafnium, tungsten, and bismuth.

Specific examples of the above-mentioned metal compound include calcium acetate, calcium chloride, calcium formate, zirconium acetate, zirconium tetrachloride, calcium sulfate, barium acetate, barium sulfate, barium phosphate, manganese chloride, manganese acetate, manganese formate dihydrate, ammonium manganese sulfate hexahydrate, cupric chloride, copper ammonium chloride (II) dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, basic aluminum polyhydroxide, aluminum sulfite, aluminum thiosulfate, polychlorinated aluminum, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, ammonium zinc acetate, zinc ammonium carbonate, titanium tetrachloride, tetraisopropyl titanate, titanium acetylacetonate, titanium lactate, chromium acetate, chromium sulfate, magnesium sulfate, magnesium chloride hexahydrate, magnesium citrate nonahydrate, sodium phosphotungstate, tungsten sodium citrate, 12-tungstophosphoric acid n-hydrate, 12-tungstosilicic acid 26-hydrate, molybdenum chloride, 12-molybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, and the like. Among them, aluminum sulfate, aluminum alum, basic aluminum polyhydroxide, aluminum sulfite, aluminum thiosulfate, polychlorinated aluminum, aluminum nitrate nonahydrate, aluminum chloride hexahydrate, zirconium nitrate, and zirconium tetrachloride are preferable.

At least two types of the above-mentioned first metal compounds are preferably contained in the first liquid. These metal compounds have different mordant dyes according to the types, and therefore, the mordanting ability can be improved by using two or more types of the first metal compounds. Thus, more specifically, it is preferable to contain metal compounds corresponding to the two or more types of mordant dyes. Various combinations are considered as the metal compound corresponding to the dyes. For example, a zirconium compound is effectively used for a black dye of common ink.

The first metal compound is contained in the first liquid preferably in the range of 0.01 to 1% by mass based on the total mass of the first liquid, and more preferably in the range of 0.05 to 0.8% by mass. The content of the first metal compound in the above-mentioned range can provide an ink jet recording medium in which bleeding of an image with time is reduced without causing any increase in curling under a low-humidity condition. Incidentally, when other mordant components described below are used together with the first metal compound, they can be contained as long as the total amount thereof is within the above-mentioned range and the effects of the present invention are not impaired.

The second metal compound to be contained in the second liquid can be used without being limited as long as they are stable under a basic condition. The second metal compounds may be a metal salt or a metal complex compound, or alternatively, an inorganic oligomer or an inorganic polymer. Preferred examples of the above-mentioned metal compound include an inorganic mordant described below. Among them, a zirconium compound, an aluminum compound, and a zinc compound are preferable, and a zirconium compound is particularly preferable. For example, ammonium zirconium carbonate, ammonium zirconium nitrate, potassium zirconium carbonate, ammonium zirconium citrate, zirconyl stearate, zirconyl octylate, zirconyl nitrate, zirconium oxychloride, zirconium hydroxychloride, and the like. Among them, ammonium zirconium carbonate is particularly preferable. The first metal compound or second metal compound is preferably a zirconium compound or an aluminum compound.

The second liquid may contain other mordant components as necessary.

A metal complex described in “Kagaku Sousetsu (Chemistry Review) No. 32 (1981)” edited by the Chemical Society of Japan, and a transition metal complex containing a transition metal such as ruthenium described in “Coordination Chemistry Review”, Vol. 84, pp. 85-277 (1988) and in Japanese Patent Application Laid-Open (JP-A) No. 2-182701 can be used as the metal complex compound.

The above-mentioned second metal compound is contained in the second liquid preferably in the amount of 0.1 to 0.8% by mass based on the total mass of the second liquid, and more preferably in the amount of 0.2 to 0.5% by mass. When the content of the second metal compound is set in the above-mentioned specific range, the degree of glossiness can be improved without causing any increase in bronzing. Incidentally, when other mordant components described below are used together with the second metal compound, they can be contained as long as the total amount thereof is within the above-mentioned range and the effects of the present invention are not impaired.

The second liquid preferably includes a basic compound. The basic compound contained in the second liquid will be described. Examples of the basic compound include an ammonium salt of weak acid, an alkali metal salt of weak acid (for instance, lithium carbonate, sodium carbonate, potassium carbonate, lithium acetate, sodium acetate and potassium acetate), an alkali earth metal salt of weak acid (for instance, magnesium carbonate, barium carbonate, magnesium acetate and barium acetate), the hydroxide of alkali metals and alkaline-earth metals, hydroxy ammonium, ammonia, a primary-a tertiary amine (for instance, ethyl amine, dimethylamine, triethylamine, polyallylamine, tripropylamine, tributhylamine, trihexylamine, dibutylamine, butylamine and N-ethyl-N-methylbutylamine), a primary-a tertiary aniline (for instance, diethylaniline, dibutylaniline, ethylaniline and aniline), pyridine which may have a substituent (for instance, 2-amino pyridine, 3-amino pyridine, 4-amino pyridine and 4-(2-hydroxyethyl)-amino pyridine). Among the above, an ammonium salt of weak acid is particularly preferable.

The weak acid is an inorganic acid or organic acid in which pKa is 2 or more described in chemical handbook basic chapter II (Maruzen Co., Ltd.) or the like. Examples of the ammonium salt of weak acid include ammonium carbonate, ammonium hydrogen carbonate, ammonium boric acid, ammonium acetate and ammonium carbamate. However, the ammonium salt of weak acid is not limited to these examples. Ammonium carbonate, ammonium hydrogencarbonate and ammonium carbamate are preferable among them; they do not remain in the layer after being dried, and thereby the ink bleeding can be reduced. Two or more types of the basic compound may be used in combination.

The basic compound is contained in the second liquid preferably in an amount of 0.5 to 10% by mass, and more preferably 1 to 5% by mass based on the total mass of the second liquid including a solvent. When the content of the basic compound is adjusted in the above-described range, sufficient hardening degree can be obtained without increasing the ammonia density too much and deteriorating the working environment.

As a first liquid in step (A), for instance, a coating liquid for an ink receiving layer which contains the fumed silica, polyvinyl alcohol (PVA), boric acid, a cationic resin, nonionic or an amphoteric surfactant and a high boiling point organic solvent can be prepared below. Each component contained in the first liquid will be described below.

The fumed silica is added to water, and a cationic resin is added further to the resultant mixture. The resultant mixture is then dispersed by a high-pressure homogenizer, a sand mill or the like. Boric acid, PVA aqueous solution (for instance, such that the amount of PVA becomes the mass of about ⅓ of the fumed silica) are added to the resultant mixture. In addition, a nonionic or an amphoteric surfactant and a high boiling point organic solvent are added and stirred, and thereby the first liquid can be prepared. The coating liquid obtained is uniform sol. The coating layer is obtained by coating the coating liquid on the support by the coating method as described below, and the porous ink receiving layer which has the three-dimensional network structure can be formed. At this time, as described above, PVA can be prevented from gelling partially by adding the PVA after the boric acid is added.

Aqueous dispersion having an average particle size of 10 to 300 nm can be prepared by grain-refining the first liquid (the coating liquid for the ink receiving layer) using a disperser. Known various dispersers such as a high speed rotating disperser, a medium stirring type disperser (a ball mill, a sand mill or the like), an ultrasonic disperser, a colloid mill disperser, and a high pressure disperser can be used as a disperser which is used for obtaining the aqueous dispersion. However, the medium stirring type disperser, the colloid mill disperser and the high pressure disperser are preferable in view of dispersing efficiently agglomerate-like fine particles formed.

In the present invention, the first liquid is preferably an acid solution. The pH of the first liquid is preferably 6.0 or less, more preferably 5.0 or less, and further preferably 4.0 or less. The pH can be adjusted by properly selecting the kind and the amounts added of the cationic resin. An organic acid or an inorganic acid may also be added for adjusting. When the pH of the first liquid is 6.0 or less, the cross-linking reaction of the water-soluble resin due to the cross-linking agent (particularly, boron compound) can be more sufficiently suppressed in the first liquid.

For instance, the first liquid (the coating liquid for an ink receiving layer) in step (A) can be coated by a known coating method using an extrusion die coater, an air doctor coater, a bread coater, a rod coater, a knife coater, a squeeze coater, a reverse roll coater, and a bar coater or the like.

The second liquid (the basic liquid) can be applied in step (B) after the coating liquid (the first liquid) for the ink receiving layer is coated. The second liquid is preferably applied before the coating layer exhibits a decreasing rate of drying. That is, the coating layer is preferably produced by applying the second liquid while the coating layer exhibits a constant rate of drying after the first liquid is coated.

The second liquid may contain a cross-linking agent and other mordant components if necessary. The hardening of the layer can be accelerated by using the second liquid that is an alkaline solution. The second liquid is preferably adjusted to a pH of 7.1 or more, more preferably a pH of 7.5 or more, and most preferably a pH of 7.9 or more. When the pH is too near an acid side, the cross-linking reaction of the water-soluble polymer included in the first liquid does not performed sufficiently by the cross-linking agent, and thereby bronzing and the defect due to the crack or the like may be caused in the ink receiving layer.

For instance, the second liquid can be prepared by adding a metal compound (for instance, 1 to 5%), a basic compound (for instance, 1 to 5%), and, if necessary, para-toluene sulfonic acid (for instance, 0.5 to 3%) to the ion-exchange water, and by stirring the resultant mixture sufficiently. The term “%” in each composition refers to solid mass.

Water, an organic solvent or the mixed solvent thereof can be used as the solvent used for preparing each liquid. Examples of organic solvents which can be used for coating include alcohols such as methanol, ethanol, n-propanol, i-propanol and methoxy propanol, ketones such as acetone and methyl ethyl ketone, tetrahydrofuran, acetonitrile, ethyl acetate, and toluene.

“Before the coating layer exhibits a decreasing rate of drying” in step (B) usually refers to the period of a few minutes immediately after coating the coating liquid for the ink receiving layer. During the period, the coating layer exhibits a constant rate of drying, during which the contained amount of the solvent (dispersing medium) in the coating layer decreases in proportion to time. For instance, the time exhibiting the “constant rate of drying” is described in Chemical Engineering Handbook (pp. 707-712, Maruzen Co., Ltd., Oct. 25, 1980).

As described above, after coating the coating liquid for an ink receiving layer (first liquid), the coating layer is dried until the coating layer formed of the first liquid exhibits a decreasing rate of drying. In general, the coating layer is dried for 0.5 to 10 minutes (preferably, for 0.5 to 5 minutes) at 40 to 180° C. (preferably, at 50 to 120° C.). The above-mentioned range is usually suitable though the drying time naturally depends on the coating amount.

Examples of methods for applying before the coating layer exhibits a decreasing rate of drying include (1) a method for coating the second liquid further on the coating layer, (2) a method for spraying by a spray or the like, and (3) a method for soaking a support on which the coating layer is formed in the second liquid.

In the method (1), for instance, a known coating method such as a curtain flow coater, an extrusion die coater, an air doctor coater, a bread coater, a rod coater, a knife coater, a squeeze coater, a reverse roll coater, and a bar coater can be used as a coating method for coating the second liquid. It is preferable to use a method in which a coater does not directly contact with the coating layer which has already been formed such as the extrusion die coater, the curtain flow coater and the bar coater.

After the second liquid is applied, the coating layer is heated in general at 40 to 180° C. for 0.5 to 30 minutes, is dried and is hardened. The coating layer is preferably heated at 40 to 150° C. for 1 to 20 minutes.

Step (A) and step (B) can be performed at the same time. That is, the second liquid (basic solution) is suitably applied at the same time as the coating of the first liquid (coating liquid for the ink receiving layer). In this case, the first liquid and the second liquid are applied simultaneously on the support (laminating layer coating) such that the first liquid is in contact with the support, and then hardened and dried. Therefore, the ink receiving layer can be formed.

For instance, the simultaneous coating (laminating layer coating) can be performed by the coating method which uses the extrusion die coater and the curtain flow coater. The coating layer formed is then dried. In this case, in general, the coating layer is dried by heating at 15 to 150° C. for 0.5 to 10 minutes, and more preferably at 40 to 100° C. for 0.5 to 5 minutes.

When the simultaneous coating (laminating layer coating) is performed by, for example, the extrusion die coater, two kinds of coating liquids exhaled simultaneously is laminated and formed near the discharge port of the extrusion die coater, that is, before the liquids move on the support, and in the state, the layer is laminated and coated on the support. When two coating liquid laminated and coated before coating moving to the support, the cross-linking reaction is easily caused in the interface of two liquids. Two liquids discharged are mixed and easy to have high viscosity near the discharge port of the extrusion die coater, and thereby the hindrance may be caused in the coating operation. Therefore, when coating simultaneously as described above, a barrier layer liquid (an intermediate layer liquid) is preferably interposed between the first liquid and the second liquid to coating in threefold simultaneously.

The barrier layer liquid can be selected without being limited. Examples of the barrier layer liquids include water and aqueous solution which contains a small amount of the water-soluble resin. The water-soluble resin is used for viscosity improver or the like in consideration of coatability. Examples of the water-soluble resins include polymers such as a cellulose system resin (for instance, hydroxypropyl methylcellulose, methyl cellulose and hydroxy ethyl methyl cellulose or the like), polyvinylpyrrolidone, and gelatin. The barrier layer liquid can also contain a mordant.

The surface smoothness, glossiness degree, transparency and coating film strength of the ink receiving layer can be improved by performing a calendering treatment between roll nips under heating and pressurizing by using a super-calender and a gross calender or the like after forming the ink receiving layer on the support. However, it is necessary to set the condition with few reduction of the void ratio since the calendering treatment may causes the reduction of the void ratio (that is, since the ink absorption performance may be reduced).

The temperature of the roll is preferably 30 to 150° C., and more preferably 40 to 100° C. when performing the calendering treatment. The line pressure between the rolls is preferably 50 to 400 kg/cm, and more preferably 100 to 200 kg/cm when performing the calendering treatment.

It is necessary to determine the layer thickness of the ink receiving layer in relation to the void ratio in the layer since the layer thickness of the ink receiving layer should have the absorption volume for absorbing all droplet in case of the ink jet recording. When the amount of ink is 8 nL/mm² and the void ratio is 60%, the layer thickness of about 15 μm or more is needed. Therefore, the layer thickness of the ink receiving layer is preferably 10 to 50 μm in case of the ink jet recording.

The pore size of the ink receiving layer has preferably a median diameter of 0.005 to 0.030 μm, and more preferably 0.01 to 0.025 μm.

The void ratio and the pore median diameter can be measured by using a mercury porosimeter (trade name: Poresizer 9320-PC2, manufactured by Shimadzu Corporation).

The ink receiving layer is preferably excellent in transparency. For example, when the ink receiving layer is formed on a transparent film, the haze value of the ink receiving layer is preferably 30% or less, and more preferably 20% or less. The haze value can be measured with a haze meter (trade name: HGM-2DP, manufactured by Suga Test Instruments Co., Ltd.).

Hereinafter, each component contained in the first liquid or the second liquid will be described in detail.

(Inorganic Particles)

The first liquid preferably includes inorganic particles. Examples of inorganic particles include silica particles such as fumed silica and hydrated silica particles, colloidal silica, titanium dioxide, barium sulfate, calcium silicate, zeolite, kaolinyte, halloysite, mica, talc, calcium carbonate, magnesium carbonate, calcium sulfate, boehmite and pseudo boehmite. These can be used singly or in combination. The inorganic particles are preferably dispersed by a cationic resin.

Especially, the fumed silica is preferably used as the inorganic particles, and the fumed silica and the other inorganic particles can be used in combination. When the fumed silica and the other inorganic particles are used in combination, the amount of the fumed silica which occupy in the total mass of the inorganic particles is preferably 90% by mass or more, and more preferably 95% by mass or more.

The silica particles are usually divided roughly into wet process particles and dry process particles (vapor phase process). In the wet process, active silica is produced by acid decomposing of silicate salt, and hydrated silica is obtained by polymerizing the active silica moderately, cohering and submerging. On the other hand, in a vapor phase method, a flame hydrolysis method and an arc method are main current. In the flame hydrolysis method, anhydrous silica is obtained by a high temperature vapor phase hydrolysis of hydrogen-silicon. In the arc method, silica sand and coke are heated, reduced and vaporized in an electric furnace by arc, and the anhydrous silica is obtained by oxidizing the resultant mixture by air. The “fumed silica” refers to anhydrous silica particles obtained by the vapor phase method.

Although the fumed silica exhibits different properties from hydrated silica due to the difference in density of the silanol group of the surface and the proportion of voids, the fumed silica is suitable for forming a three-dimensional structure having high void ratio. The reason is not clear. It is considered that the density of silanol group on the surface of the fine particle is 5 to 8 pieces/nm² in the hydrated silica and thereby the silica particles aggregate easily. On the other hand, it is considered that the density of silanol group on the surface of the fine particle is 2 to 3 pieces/nm² in the fumed silica and the silica particles flocculate, and thereby the void ratio is high.

Since the fumed silica has a large specific surface area especially, the silica has high ink absorption property and high holding efficiency. Since the silica has low refractive index, the transparency can be imparted to the ink receiving layer when dispersing to appropriate particle size, and high color density and excellent color can be obtained. It is important that the receiving layer is transparent in view of obtaining high color density and excellent color glossiness even when applying to photographic glossy paper or the like.

The average primary particle size of the fumed silica is preferably 20 nm or less, more preferably 10 nm or less, and most preferably 3 to 10 nm. The particles of the fumed silica adhere easily to each other by the hydrogen bonding due to the silanol group. When the average primary particle size is 20 nm or less, the structure having large void ratio can be formed. Therefore, the ink absorption property can be effectively improved, and the transparency and surface glossiness of the ink receiving layer can be improved. The fumed silica may be used in the state of primary particle, and also may be used in the state of secondary particle.

The fumed silica is preferably used in a dispersed state. The fumed silica can be dispersed by using a cationic resin as a dispersing agent (a cohesion preventing agent), and can be used as a fumed silica dispersion. The cationic resin is not particularly limited. However, a cationic polymer such as a primary, secondary or tertiary amino group and the salt thereof, and a quaternary ammonium group are preferable, and the examples thereof include the examples of other mordant components described below. A silane coupling agent is also preferably used as a dispersing agent. Water soluble type or water emulsion type or the like can be preferably used. Examples include dicyan based cationic resin such as dicyan diamide-formalin condensation polymer, polyamine based cationic resin such as dicyan amide-diethylene triamine condensation polymer, epichlorhydrin-dimethylamine addition polymer, dimethyl diaryl ammonium chloride-SO₂ copolymer, diaryl amine salt-SO₂ copolymer, dimethyl diaryl ammonium chloridepolymer, polymer of aryl amine salt, dialkyl amino ethyl (meth)acrylate quaternary salt polymer, polycationic based cationic resin such as acryl amide-diaryl amine salt copolymer.

Especially, it is preferable that the fumed silica has a specific surface area of 200 m²/g or more as measured according to the BET method. The porous structure is obtained by containing the fumed silica, and thereby the ink absorption performance can be improved. The quick-drying performance and resistance to ink bleeding can be improved by using the silica particles having a specific surface area of 200 m²/g or more, and thereby the image quality and the printing density can be improved.

Herein, the BET method is one of methods for measuring the surface area of particle by a vapor phase adsorption method, and a method for obtaining a total surface area of the sample of 1 g, that is, a specific surface area from an adsorption isotherm. Nitrogen gas is usually used an adsorption gas, and the amount of adsorption is generally measured from the change in the pressure or volume of an adsorbed gas. There is a Brunauer Emmett and Teller (BET) equation which shows the isotherm of multimolecular adsorption. The amount of adsorption is obtained based on the equation, and the surface area is obtained by multiplying the amount of adsorption by the area that one adsorption molecule occupies on the surface.

(Water-Soluble Resin)

The first liquid includes a water-soluble resin. Examples of the water-soluble resins include polyvinyl alcohol (PVA), polyvinyl acetal, cellulose based resin (for instance, methyl cellulose (MC), ethyl cellulose (EC), hydroxy ethyl cellulose (HEC), and carboxymethylcellulose (CMC)), chitins, chitosans, starch; polyethylene oxide (PEO) which is a resin having ether bonding, polypropylene oxide (PPO), polyethylene glycol (PEG), polyvinyl ether (PVE); polyacrylamide (PAAM) which is a resin having an amid group or amide bonding, poly vinylpyrrolidone (PVP), polyacrylate which has a carboxyl group as a dissociated group, a maleic acid resin, alginate, and gelatins. These can be also used singly or in combination.

Polyvinyl alcohol is preferable among them, and polyvinyl alcohol and the other water-soluble resin can be used in combination. When polyvinyl alcohol and the other water-soluble resin are used in combination, the amount of the polyvinyl alcohol which occupies in the total mass of the water-soluble resin is preferably 90% by mass or more, and more preferably 95% by mass or more.

The polyvinyl alcohol includes cation-modified polyvinyl alcohol, anion-modified polyvinyl alcohol, silanol-modified polyvinyl alcohol, and other polyvinyl alcohol derivatives in addition to polyvinyl alcohol (PVA). The polyvinyl alcohol can be used singly or in combination.

The polyvinyl alcohol (PVA) has the hydroxyl group in the structure unit. The hydroxyl group and the silanol group formed on the surface of silica particles forms the hydrogen bonding, and the three-dimensional network structure for making the secondary particles of the silica particles a unit chain is easily formed. The ink receiving layer of the porous structure having high void ratio can be formed by forming the three-dimensional network structure.

Thus, the ink receiving layer having porous structure rapidly absorbs ink by capillary phenomenon at the time of the ink jet recording, and can form dots having excellent circularity without ink bleeding.

The content of the water-soluble resin (particularly, polyvinyl alcohol) is preferably 9 to 40% by mass, and more preferably 12 to 33% by mass based on the total solid mass of the layer when the ink receiving layer is formed in view of preventing the reduction of the film strength due to the excessive few amount and the crack at drying, and in view of preventing ink absorption property from reducing by reducing the void ratio due to the excessive much amount.

The number average degree of polymerization of the polyvinyl alcohol (PVA) is preferably 1800 or more, and more preferably 2000 or more in view of crack prevention. PVA of the saponification degree 88% or more is preferable, and PVA of the saponification degree of 95% or more is particularly preferable in view of the transparency and the viscosity of the coating liquid for forming the ink receiving layer.

Content Ratio of Inorganic Particles and Water-Soluble Resin

The content ratio (PB ratio (i:p); the mass of the inorganic particles to 1 part by mass of the water-soluble resin) of the inorganic particles (i) and the water-soluble resins (p) greatly influences the layer structure when forming the layer. That is, the increase in PB ratio causes the increase in the void ratio, the pore volume, and the surface area (per unit mass). The PB ratio is preferably 1.5:1 to 10:1 in view of preventing the reduction of film strength caused by the increase of the PB ratio and the crack at the time of drying, and preventing the deterioration of the ink absorption property caused by the reduction of the void ratio, which results from that voids are apt to be blocked by the resin due to the decrease of the PB ratio.

Since an ink jet recording medium is stressed when the ink jet recording medium passes through the transportation system of an ink jet printer, the ink receiving layer should have sufficient film strength. The ink receiving layer should have sufficient film strength to prevent the crack and peeling of the ink receiving layer when cutting the ink jet recording medium in a sheet shape. Therefore, the PB ratio is preferably 5:1 or less, and more preferably 2:1 or more in view of securing the high-speed ink absorption property in the ink jet printer.

For instance, a coating liquid in which the fumed silica having average primary particle size of 20 nm or less and the water-soluble resin of PB ratio 2:1 to 5:1 are completely dispersed in an aqueous solution is coated on the support. When the coating layer is dried, the three-dimensional network structure which makes the secondary particle of the silica particles a chain unit is formed. Therefore, a translucent porous membrane can be easily formed in which the average pore size is 30 nm or less; the void ratio is 50 to 80%; the pore specific volume is 0.5 ml/g or more; specific surface area is 100 m²/g or more.

(Cross-Linking Agent)

The cross-linking agent may be contained in the first liquid, and may be also contained in the second liquid.

The cross-linking agent can cross-link the water-soluble resin, and the inclusion of the cross-linking agent can form the porous layer hardened by the cross-linking reaction of the cross-linking agent and the water-soluble resin.

The boron compound is preferable for cross-linking of the water-soluble resin, especially polyvinyl alcohol resin. Examples of the boron compound include borax, boric acid, boric acid salt (for instance, orthoboric acid salt, InBO₃, ScBO₃, YBO₃, LaBO₃, Mg₃(BO₃)₂, CO₃(BO₃)₂, diboric acid salt (for instance, Mg₂B₂O₅, CO₂B₂O₅), meta boric acid salt (for instance, LiBO₂, Ca(BO₂) 2′ NaBO₂, KBO₂), tetraboric acid salt (for instance, Na₂B₄O₇.10H₂O) and pentaboric acid salt (for instance, KB₅O₈ 4H₂O, Ca₂B₆O₁₁.7H₂O, and CsB₅O₅). The borax, the boric acid, and the boric acid salt are preferable among them with a view to enabling the prompt cross-linking reaction, and especially the boric acid is preferable.

The following compounds can be used in addition to the boron compound. Examples include aldehyde compounds such as formaldehyde, glyoxal and glutalaldehyde; ketone compounds such as diacetyl and cyclopentanedione; activated halogen compounds such as bis(2-chloroethylurea)-2-hydroxy-4,6-dichloro-1,3,5-triazine, and 2,4-dichloro-6-S-triazine sodium salt; activated vinyl compounds such as divinyl sulfonic acid, 1,3-vinylsulfonyl-2-propanol, N,N′-ethylene bis(vinylsulfonyl acetamido), 1,3,5-triacryloyl-hexahydro-5-triazine; N-methylol compound such as dimethylol urea and methyloldimethylhydantoin; melamine resin (for instance, methylol melamine and alkylated methylol melamine); epoxy resin; isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; Epoxy system compound such as glycerol triglycidyl ether; ethyleneimino compounds such as 1,6-hexamethylene-N,N′-bis ethylene urea; halogenated carboxy aldehyde compounds such as mucochlor acid and mucophenoxychlor acid; dioxane system compounds such as 2,3-dihydroxy dioxane; metal-containing compounds such as titanium lactate, aluminum sulfate, chrome alum, potassium alum, zirconyl acetate and chrome acetate, polyamine compounds such as tetraethylenepentamine, hydrazide compounds such as adipic dihydrazide, and low molecular weight compound or polymer or the like which contains oxazollin groups of two or more. The cross-linking agent may be used singly or in combination.

The cross-linking agent may be added to the coating liquid for the ink receiving layer and/or the coating liquid for forming the adjacent layer of the ink receiving layer when the coating liquid for the ink receiving layer is coated. The cross-linking agent can be supplied to the ink receiving layer, for example, by coating the coating liquid for the ink receiving layer on the support on which the coating liquid including the cross-linking agent is coated beforehand, or by overcoating the second liquid (for instance, a cross-linking agent solution) after coating the coating liquid for the ink receiving layer which contains the cross-linking agent or contains no cross-linking agent and drying.

For instance, the cross-linking agent may be applied in the following manner. Here, boron compound will be used as an example. When the ink receiving layer is formed by coating a coating liquid (first liquid) for an ink receiving layer, and hardening by cross-linking, the layer is hardened by cross-linking by applying the second liquid to the coating layer either (1) at the same time as the coating of the first liquid or (2) before the coating layer formed by coating the first liquid exhibits a decreasing rate of drying during drying of the coating layer. The boron compound as a cross-linking agent may be contained either in the first liquid or in the second liquid, and may be contained in both liquids. When the ink receiving layer is constituted in two or more layers, the coating liquid of two or more can be coated over each other, and the second liquid may be applied on the formed multiple layers.

The amount of the cross-linking agent to be used is preferably 1 to 50% by mass to the mass of the water-soluble resin, and more preferably 5 to 40% by mass.

(Surfactant)

It is preferable that the first liquid or second liquid includes a surfactant. Any of a cation based, an anion based, a nonion based, an amphoteric, a fluorine based, and a silicon based surfactants can be used as a surfactant. The surfactants may be used singly or in combination.

Examples of the nonion based surfactants include polyoxyalkylenealkylether and polyoxyalkylenealkylphenylethers (for instance, diethylene glycol monoethyl ether, diethylene glycoldiethyl ether, polyoxy ethylene lauryl ether, polyoxy ethylene stearyl ether, polyoxy ethylene nonylphenyl ether or the like), oxyethylene/oxypropylene block copolymer, sorbitan fatty acid esters (for instance, sorbitan mono laurate, sorbitan monoorate, sorbitan triorate or the like), polyoxyethylene sorbitan fatty acid esters (for instance, polyoxyethylene sorbitan mono laurate, polyoxyethylene sorbitan monoorate, polyoxyethylene sorbitan triorate or the like), polyoxyethylenesorbitol fatty acid esters (for instance, polyoxyethylene sorbit tetraoleate or the like), glycerin fatty acid esters (for instance, glycerol mono orate or the like), polyoxyethylene glycerin fatty acid esters (monostearate polyoxyethylene glycerin, monooleate polyoxyethylene glycerin or the like), polyoxyethylene fatty acid esters (polyethylene glycol mono laurate, polyethylene glycol monoorate or the like), polyoxyethylene alkylamine, acetylenic glycols (for instance, 2,4,7,9-tetramethyl-5-desine-4,7-diol and ethylene oxide adduct of the diol, propylene oxide adduct or the like). Polyoxyalkylene alkyl ethers are preferable. The nonion based surfactant may be contained in the coating liquid for the ink receiving layer.

Examples of the amphoteric surfactants include an amino acid type, a carboxy ammonium betaine type, a sulfone ammonium betaine type, an ammonium sulfate betaine type and imidazolium betaine type. For instance, the amphoteric surfactants which are described in U.S. Pat. No. 3,843,368, JP-A Nos. 59-49535, 63-236546, 5-303205, 8-262742 and 10-282619 or the like can be preferably used. An amino acid type amphoteric surfactant is preferable as the amphoteric surfactant. The amino acid type amphoteric surfactant is derivatized from an amino acid (glycine, glutamic acid, and histidine acid or the like) as described in JP-A No. 5-303205. Examples of the amino acid type amphoteric surfactants include N-amino acyl acid in which a long-chain acyl group is introduced and its salt.

Examples of the anion based surfactants include a fatty acid salt (for instance, sodium stearate and potassium oleate), an alkyl sulfate ester salt (for instance, sodium lauryl sulfate, triethanol amine lauryl sulfate), a sulfonate (for instance, sodium dodecylbenzenesulfonate), an alkylsulfo succinic acid salt (for instance, dioctylsulfo sodium succinate), alkyldiphenyl ether disulfonate and alkyl phosphate.

Examples of the cation based surfactants include alkyl amine salt, a quaternary ammonium salt, a pyridinium salt, an imidazolium salt.

Examples of the fluorine based surfactants include compounds derivatized through the intermediate having perfluoro alkyl group by using a method such as an electrolysis fluorination, telomerization and oligomerization. Examples include perfluoro alkyl sulfonate, perfluoro alkylcarboxylate, perfluoro alkylethyleneoxide adduct, perfluoro alkyl trialkyl ammonium salt, perfluoro alkyl group-containing oligomer, and perfluoro alkyl phosphate ester or the like.

A silicone oil modified by an organic group is preferable as the silicone based surfactant, and has the structure in which the side chain of the siloxane structure is modified by the organic group, the structure in which both terminals are modified, and the structure in which one of terminals is modified. Examples of the organic group modification include amino modification, polyether modification, epoxy modification and carboxylic modification, carbinol modification, alkyl modification, aralkyl modification, phenol modification, and fluorine modification.

The content of the surfactant contained in the coating liquid for the ink receiving layer is preferably 0.001 to 2.0%, more preferably 0.01 to 1.0%.

The ink jet recording medium produced by the method for producing an ink jet recording medium of the present invention as described above includes at least one ink receiving layer formed on a support. The ink receiving layer contains metal compounds, a water-soluble resin and a cross-linking agent. The ink receiving layer may further contain a mordant component other than the metal compounds and other components if necessary.

Support

A transparent support made of transparent material such as plastic, and opaque support composed of an opaque material such as paper can be used as a support which can be used for the present invention. Especially, a transparent support or an opaque support having high glossiness is preferably used to make the best use of the transparency of the ink receiving layer. Read-only optical disks such as CD-ROM and DVD-ROM, recordable optical disks such as CD-R and DVD-R, and rewritable optical disks can be used as a support, and the ink receiving layer can be formed on both sides of a label.

The material which is transparent and can endure radiant heat when used on an OHP and a backlight display is preferable as materials which can be used for the transparent support. Examples of the materials include polyesters such as polyethylene terephthalate (PET); polysulfone, polyphenylene oxide, polyimide, polycarbonate and polyamide. The polyesters are preferable among them, and especially, the polyethylene terephthalate is preferable.

The thickness of the transparent support is not particularly limited. However, the thickness of 50 to 200 μm is preferable in view of easy handling.

An opaque support having high glossiness whose the surface on which the ink receiving layer is formed has a glossiness degree of 40% or more is preferable. The glossiness degree is a value determined according to the method described in JIS P-8142 (75-degree specular glossiness test method of paper and hardboard). Examples of the supports include the following supports.

Examples include paper supports having high glossiness such as art paper, coat paper, cast coat paper and baryta paper used for a support for a silver salt photography or the like; polyesters such as polyethylene terephthalate (PET), cellulose esters such as nitrocellulose, cellulose acetate and cellulose acetate butilate, opaque high glossiness films which are constituted by containing white pigment or the like in plastic films such as polysulfone, polyphenylene oxide, polyimide, polycarbonate and polyamide (a surface calendering treatment may be performed); or, the supports in which the coating layer made of polyolefin which contains or does not contain the white pigment was formed on the surface of each various paper support, the transparent support, or a high glossiness film containing the white pigment. Also, a white pigment-containing foam polyester film (for instance, a foamed PET which contains the polyolefin fine particles, and contains voids formed by drawing) is preferable.

The thickness of the opaque support is not particularly limited. However, the thickness of 50 to 300 μm is preferable in view of handling.

One treated by a corona discharge treatment, a glow discharge treatment, a flame treatment and an ultraviolet radiation treatment or the like may be used for the surface of the support so as to improve wettability and adhesion property.

Next, base paper used for the paper support will be described in detail.

The base paper is mainly made of wood pulp, and is made by using a synthetic pulp such as polypropylene in addition to the wood pulp if necessary, or a synthetic fiber such as nylon or polyester. LBKP, LBSP, NBKP, NBSP, LDP, NDP, LUKP and NUKP can be used as the wood pulp. It is preferable to use more LBKP, NBSP, LBSP, NDP and LDP which contain a lot of short fibers. The ratio of LBSP and/or LDP is preferable in the range between 10% by mass and 70% by mass. A chemical pulp with few impurities (sulfate pulp and sulfite pulp) is preferably used as the pulp, and a pulp in which whiteness is improved by bleaching, is also useful.

Sizing agents such as higher fatty acid and alkyl ketene dimer, white pigments such as calcium carbonate, talc and titanium oxide, paper strength agents such as starch, polyacrylamide and polyvinyl alcohol, fluorescent brightening agents, water retention agents such as polyethylene glycols, dispersing agents, and softening agents such as a quaternary ammonium can be properly added to the base paper.

The freeness of pulp used for papermaking is preferably 200 to 500 ml in the regulation of CSF. The sum of 24 mesh remainder (% by mass) and 42 mesh remainder (% by mass) is preferably 30 to 70% in the regulation of JIS P-8207. The % by mass of 4 mesh remainder is preferably 20% by mass or less. The basic weight of the base paper is preferably 30 to 250 g, and particularly preferably 50 to 200 g. The thickness of the base paper is preferably 40 to 250 μm. High smoothness can be imparted to the base paper by calendering treatment at the making paper step or after making paper. The density of the base paper is generally 0.7 to 1.2 g/m² (JIS P-8118). In addition, the strength degree of the base paper is preferably 20 to 200 g in the condition provided in JIS P-8143.

A surface sizing agent may be coated on the surface of the base paper, and a sizing agent same as the size which can be added to the base paper can be used as the surface sizing agent. It is preferable that the pH of the base paper is 5 to 9 when measured by a hot water extraction method provided by JIS P-8113.

In general, the both surfaces of the base paper can be covered with polyethylene. Examples of polyethylenes include low density polyethylene (LDPE) and/or high density polyethylene (HDPE). Other LLDPE, polypropylene and the like can be also used partly.

Especially, in the polyethylene layer on the side on which the ink receiving layer is formed, it is preferable that rutile type or anatase type titanium oxide, a fluorescent brightening agent and a ultramarine blue pigment are added to polyethylene, and thereby the opaque degree, the whiteness and the hueare improved so as to be performed widely in photographic printing paper. Herein, the content of titanium oxide is preferably about 3 to 20% by mass, and more preferably 4 to 13% by mass to polyethylene. The thickness of the polyethylene layer is not limited to a particular thickness, and preferably 10 to 50 μm on each of both side surfaces of the layer. Further, an undercoat layer can be formed to give adhesion with the ink receiving layer on the polyethylene layer. Water polyester, gelatin, and PVA are preferably used as the undercoat layer. The thickness of the undercoat layer is preferably 0.01 to 5 μm.

A polyethylene coating paper can be used as a glossy paper. Also, the paper in which the matte surface or the silky surface obtained in usual photographic printing paper is formed by performing so-called typing treatment when polyethylene is coated on the surface of the base paper by melting and extruding can be used.

Next, other mordant components and other components will be described in detail.

Other Mordant Components

In the present invention, in addition to the above-described metal compounds, the other mordant components can be contained for further improving resistance to image bleeding over time and improving in water resistance.

Examples of the other mordant components include an organic mordant such as a cationic polymer (a cationic mordant) and an inorganic mordant such as a water-soluble metal compound. A cationic mordant is preferably a polymer mordant having a primary, secondary or tertiary amino group, or a quaternary ammonium group as a cationic functional group. A cationic non-polymer mordant can be also used.

The polymer mordant is preferably a homopolymer of a monomer (mordant monomer) having a primary, secondary or tertiary amino group and its salt, or a quaternary ammoniumgroup, a copolymer or a condensation polymer of the mordant monomer and the other monomer (non-mordant monomer). The polymer mordants can be used in the form of a water-soluble polymer or water dispersible latex particles.

Examples of the mordant monomers include trimethyl-p-vinyl benzyl ammonium chloride, trimethyl-m-vinyl benzyl ammonium chloride, triethyl-p-vinyl benzyl ammonium chloride, triethyl-m-vinyl benzyl ammonium chloride, N,N-dimethyl-N-ethyl-N-p-vinyl benzyl ammonium chloride, N,N-diethyl-N-methyl-N-p-vinyl benzyl ammonium chloride, N,N-dimethy-N-n-propyl-N-p-vinyl benzyl ammonium chloride, N,N-dimethyl-N-n-octyl-N-p-vinyl benzyl ammonium chloride, N,N-dimethyl-N-benzyl-N-p-vinyl benzyl ammonium chloride, N,N-diethyl-N-benzyl-N-p-vinyl benzyl ammonium chloride, N,N-dimethyl-N-(4-methyl) benzyl-N-p-vinyl benzyl ammonium chloride, N,N-dimethyl-N-phenyl-N-p-vinyl benzyl ammonium chloride; trimethyl-p-vinyl benzyl ammonium bromide, trimethyl-m-vinyl benzyl ammonium bromide, trimethyl p-vinyl benzyl ammonium sulfonate, trimethyl-m-vinyl benzyl ammonium sulfonate, trimethyl-p-vinyl benzyl ammonium acetate, trimethyl-m-vinyl benzyl ammonium acetate, N,N,N-triethyl-N-2-(4-vinylphenyl) ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl) ethyl ammonium acetate; N,N-dimethyl aminoethyl (meth)acrylate, N,N-diethyl aminoethyl (meth)acrylate, N,N-dimethyl aminopropyl (meth)acrylate, N,N-diethyl aminopropyl (meth)acrylate, N,N-dimethyl aminoethyl (meth)acrylamide, N,N-diethyl aminoethyl (meth)acrylamide, N,N-dimethyl amino propyl (meth)acrylamide, methyl chloride of N,N-diethyl amino propyl (meth)acrylamide, ethyl chloride, methylbromide, ethylbromide, a quaternary compound of methyliodide or ethyliodide, or a sulfonate, an alkyl sulfonate, an acetate or an alkyl carboxylate or the like which substitute the anions.

Examples of the compounds include monomethyl diallyl ammonium chloride, trimethyl-2-(methacryloyloxy) ethyl ammonium chloride, triethyl-2-(methacryloyloxy) ethyl ammonium chloride, trimethyl-2-(acryloyloxy) ethyl ammonium chloride, triethyl-2-(acryloyloxy) ethyl ammonium chloride, trimethyl-3-(methacryloyloxy) propyl ammonium chloride, triethyl-3-(methacryloyloxy) propyl ammonium chloride, trimethyl-2-(methacryloylamino) ethyl ammonium chloride, triethyl-2-(methacryloyamino) ethyl ammonium chloride, trimethyl-2-(acryloylamino) ethyl ammonium chloride, triethyl-2-(acryloylamino) ethyl ammonium chloride, trimethyl-3-(methacryloylamino) propyl ammonium chloride, triethyl-3-(methacryloylamino) propyl ammonium chloride, trimethyl 3-(acryloylamino) propyl ammonium chloride, triethyl-3-(acryloylamino) propyl ammonium chloride; N,N-dimethyl-N-ethyl-2-(methacryloyloxy) ethyl ammonium chloride, N,N-diethyl-N-methyl-2-(methacryloyloxy) ethyl ammonium chloride, N,N-dimethyl-N-ethyl-3-(acryloylamino) propyl ammonium chloride, trimethyl-2-(methacryloyloxy) ethyl ammonium bromide, trimethyl-3-(acryloylamino) propyl ammonium bromide, trimethyl-2-(methacryloyloxy) ethyl ammonium sulfonate, trimethyl-3-(acryloylamino) propyl ammonium acetate. Examples of the other monomers capable of being copolymerized include N-vinyl imidazole and N-vinyl-2-methylimidazole. The vinyl amine unit can be obtained by the hydrolysis after polymerized by using the polymerization unit of N-vinyl acetamide, N-vinyl formamide or the like, and its salt can be also used.

The non-mordant monomer does not contain a primary, secondary or tertiary amino group and its salt, or the basic or the cationic part of a quaternary ammonium group or the like. The non-mordant monomer refers to a monomer that does not interact with dye contained in ink jet ink, or a monomer in which the interaction is substantially small. Examples of the non-mordant monomers include alkyl (meth)acrylate ester; cycloalkyl (meth)acrylate ester such as cyclohexyl (meth)acrylate; aryl (meth)acrylate ester such as phenyl (meth)acrylate; aralkyl ester such as benzil (meth)acrylate; aromatic vinyls such as styrene, vinyl toluene and α-methyl styrene; vinyl esters such as vinyl acetate, vinyl propionate and vinyl versatate; allyl esters such as allyl acetate; a halogen-containing monomer such as vinylidene chloride and vinyl chloride; vinyl cyanide such as (meth)acrylonitrile; olefins such as ethylene and propylene.

The alkyl (meth)acrylate ester having 1 to 18 carbon atoms in the alkyl part is preferable. Examples of alkyl (meth)acrylate esters include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethyl hexyl (meth)acrylate, lauryl (meth)acrylate and stearyl (meth)acrylate. Methyl acrylate, ethyl acrylate, methyl methacrylate, ethyl methacrylate and hydroxy ethyl methacrylate are preferable among them. The non-mordant monomers can be also used singly or in combination.

Further, preferable examples of the polymer mordants include polydiallyldimethyl ammonium chloride, polymethacryloyloxyethyl-β-hydroxy ethyl dimethyl ammonium chloride, polyethylenimine, polyallylamine and its modified body, polyallylamine hydrochloride, a polyamide-polyamine resin, cationized starch, dicyandiamide formalin condensate, dimethyl-2-hydroxy propyl ammonium salt polymer, polyamidine, polyvinyl amine, and a cationic polyurethane resin described in JP-A No. 10-86505.

The polyallylamine modified body is obtained by adding 2 to 50 mol % of acryl nitrile, chloromethylstyrene, TEMPO, epoxy hexane, sorbic acid or the like to polyacrylamine. The polyallylamine modified body obtained by adding 5 to 10 mol % of acryl nitrile, chloromethylstyrene, or TEMPO to polyacrylamine is preferable. Especially, the polyallylamine modified body obtained by adding 5 to 10 mol % of TEMPO to polyacrylamine is preferable in view of showing ozone discoloring prevention effect.

The mordant has preferably a weight average molecular weight of 2,000 to 300,000. The molecular weight which is in the above-mentioned range can improve water resistance and resistance to bleeding over time.

Other Components

In addition, the ink receiving layer may contain the following components if necessary.

To restrain the deterioration of the colorant, a discoloring prevention agent such as various ultraviolet absorbers, surfactants, antioxidants and singlet oxygen quencher may be preferably contained.

Examples of the ultraviolet absorbers include cinnamic acid derivative, benzophenone derivative and benzotriazolyl phenol derivative. Specific examples include α-cyano-phenyl cinnamic acid butyl, o-benzotriazole phenol, o-benzotriazole-p-chlorophenol, o-benzotriazole-2,4-di-t-butyl phenol, o-benzotriazole-2,4-di-t-octyl phenol. A hindered phenol compound can be also used as an ultraviolet absorber, and a phenol derivative in which at least one or more of the second position and the sixth position is substituted by a diverging alkyl group is preferable.

A benzotriazole based ultraviolet absorber, a salicylic acid based ultraviolet absorber, a cyano acrylate based ultraviolet absorber, and oxalic acid anilide based ultraviolet absorber or the like can be also used. For instance, the ultraviolet absorbers are described in JP-A Nos. 47-10537, 58-111942, 58-212844, 59-19945, 59-46646, 59-109055 and 63-53544, Japanese Patent Application Publication (JP-B) Nos. 36-10466, 42-26187, 48-30492, 48-31255, 48-41572, 48-54965 and 50-10726, U.S. Pat. Nos. 2,719,086, 3,707,375, 3754919 and 4220711 and the like.

A fluorescent brightening agent can be also used as an ultraviolet absorber, and specific examples include a coumalin based fluorescent brightening agent. Specific examples are described in JP-B Nos. 45-4699 and 54-5324, and the like.

Examples of the antioxidants are described in EP 223739, 309401, 309402, 310551, 310552 and 459416, D.E. Patent No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212, U.S. Pat. Nos. 4,814,262 and 4,980,275.

Specific examples of the antioxidants include 6-ethoxy-1-phenyl-2,2,4-trimethy-1,2-dihydroquinoline, 6-ethoxy-1-octyl-2,2,4-trimethyl-1,2-dihydroquinoline, 6-ethoxy-1-phenyl-2,2,4-trimethy-1,2,3,4-tetrahydroquinoline, 6-ethoxy-1-octyl-2,2,4-trimethyl-1,2,3,4,-tetrahydroquinoline, nickel cyclohexanoate, 2,2-bis (4-hydroxyphenyl)propane, 1,1-bis(4-hydroxyphenyl)-2-ethylhexane, 2-methy-4-methoxy-diphenylamine, 1-methyl-2-phenyl indole.

The discolorating prevention agents may be also used singly or in combination. The discolorating prevention agent may be water soluble, dispersed and emulsion, and can be contained in a microcapsule. The amount of addition of the discolorating prevention agent is preferably 0.01 to 10% by mass of the coating liquid for the ink receiving layer.

The ink receiving layer may contain various inorganic salts, acid and alkali as a pH adjuster to improve the dispersing property of inorganic particles. Further, the ink receiving layer may also contain metal oxide fine particles having electroconductivity to suppress the friction electrification and peeling electrification of the surface, and various mat agents to reduce the friction property of the surface.

[Ink Jet Recording Medium]

The ink jet recording medium of the present invention is an ink jet recording medium obtained by the above-mentioned method for producing an ink jet recording medium according to the present invention, and is characterized in that all types of metal compounds contained in the ink receiving layer are distributed more extensively in a direction away from a support.

The ink jet recording medium of the present invention is specifically an ink jet recording medium obtained by the method for producing an ink jet recording medium, and is characterized in that the ratio of concentration of all types of metal compounds in the ink receiving layer satisfies the following expression:
0.8<C1/C2<1.0
wherein C1 and C2 respectively represent a relative concentration of the metal compounds in a layer that contacts the support and in a layer that does not contact the support when the ink receiving layer is divided into two equal parts by the cross section parallel to the support.

The ink jet recording medium of the present invention can be produced by the above-mentioned method for producing an ink jet recording medium according to the present invention. Due to the respective contents of the first metal compound in the first liquid and the second metal compound in the second liquid being adjusted, all kinds of metal compounds in the ink receiving layer are brought into a state of being distributed more extensively in the direction away from the support. Further, the ratio C1/C2 in the above-mentioned range causes no aggregation of dyes on the surface of the ink receiving layer, which is particularly effective for the purpose of preventing bronzing.

Incidentally, measurement of the above-mentioned ratio C1/C2 can be performed using TOF-SIMS measurement of the cross section in the ink receiving layer.

In the present invention, the ink receiving layer may contain an acid. Due to addition of an acid, the surface pH of the ink receiving layer is adjusted to preferably 3 to 6, and further preferably 3 to 5. When the pH is adjusted in the above-mentioned range, resistance to yellow discoloration of a white background portion improves. The surface pH is measured using method A (coating method) among surface pH measurements set up by Technical Association of the Pulp and Paper Industry, Inc. (J. TAPPI). For example, the above-mentioned measurement can be performed using the paper surface pH measurement set “Type MPC” produced by Kyoritsu Chemical-Check Lab., Corp., which set corresponds to the above-mentioned method A.

Specific examples of the acid include formic acid, acetic acid, glycolic acid, oxalic acid, propionic acid, malonic acid, succinic acid, adipic acid, maleic acid, malic acid, tartaric acid, citric acid, benzonic acid, phthalic acid, isophthalic acid, glutaric acid, gluconic acid, lactic acid, aspartic acid, glutamic acid, salicylic acid, salicylic metal salt (salts of Zn, Al, Ca, Mg or the like), methansulfonic acid, itaconic acid, benzenesulfonic acid, toluenesulfonic acid, trifluoromethansulfonic acid, styrenesulfonic acid, trifluoroacetic acid, barbituric acid, acrylic acid, methacrylic acid, cinnamic acid, 4-hydroxy benzoate, amino benzoate, naphthalenedisulfonic acid, hydroxybenzene sulfonic acid, toluenesulfinic acid, benzenesulfinic acid, sulfanilic acid, sulfamic acid, α-resorcic acid, β-resorcic acid, γ-resorcic acid, gallic acid, phloroglycin, sulfosalicylic acid, ascorbic acid, erythorbic acid, bisphenol acid, hydrochloric acid, nitric acid, sulfuric acid, phosphoric acid, polyphosphoric acid, boric acid and boric acid. The amount of these acids to be added may be determined so that the surface pH of the ink receiving layer becomes 3 to 6.

The above-mentioned acids may also be used in the form of a metal salt (for example, a salt of sodium, potassium, calcium, cesium, zinc, copper, iron, aluminum, zirconium, lanthanum, yttrium, magnesium, strontium, cerium or the like), or in the form of an amine salt (for example, ammonia, triethylamine, tributylamine, piperazine, 2-methyl piperazine, and polyallylamine).

### EXAMPLES

Next, the present invention will be explained by way of examples below, however, it is not limited to these examples. In the examples, an ink jet recording sheet is produced as an example of the ink jet recording medium, and “part” and “%” are all based on mass, unless otherwise specified.

### Example 1

(Preparation of Support)

50 parts of LBKP made of acacia and 50 parts of LBKP made of aspen were each beaten to a Canadian freeness of 300 ml by a disc refiner, thereby preparing pulp slurry.

Added to the obtained pulp slurry were 1.3% of cationic starch (CATO 304L, manufactured by National Starch and Chemical), 0.15% of anionic polyacrylamide (Polyacron ST-13, manufactured by SeikoPMC Corporation), 0.29% of alkylketene dimer (Sizepine K, manufactured by Arakawa Chemical Industries., Ltd.), 0.29% of epoxidized amide behenate, and 0.32% of polyamide polyamine epichlorohydrin (Arafix 100, manufactured by Arakawa Chemical Industries., Ltd.). Thereafter, 0.12% of antifoaming agent was further added.

In a step in which the pulp slurry prepared as described above is made into paper using a Fourdrinier paper machine and is dried with a felt surface of web being pushed against a drum dryer cylinder via a dryer canvas, the tensile force of the dryer canvas was set at 1.6 kg/cm and the resultunt paper was dried. Thereafter, 1 g/m² of polyvinyl alcohol (KL-118, manufactured by Kuraray Co., Ltd.) was applied to both surfaces of base paper using a size press, and dried, and was further subjected to calendering treatment. The base paper (substrate paper) having a basis weight of 166 g/m² and a thickness of 160 μm was obtained.

A wire surface (backface) side of the resulting substrate paper was subjected to corona discharge treatment, and thereafter, coated with high density polyethylene using a melt extruder in the thickness of 25 μm, thereby forming a thermoplastic resin layer having a matte surface (hereinafter, the resin layer surface is referred to “backface”). The thermoplastic resin layer on the backface side was further subjected to corona discharge treatment, and thereafter, coated with a dispersion liquid obtained by dispersing aluminum oxide (Alumina Sol 100, manufactured by Nissan Chemical Industries., Ltd.) and silicon dioxide (SNOWTEX 0, manufactured by Nissan Chemical Industries., Ltd.), as antistatic agents, into water in a mass ratio of 1:2 such that the mass after dried was 0.2 g/m².

Further, the felt surface (front surface) side with no thermoplastic resin layer formed thereon was subjected to corona discharge treatment, and thereafter, was adjusted so as to contain 10% of anatase type titanium dioxide and 0.3% of ultramarine blue manufactured by Tokyo Printing Ink Mfg. Co., Ltd., and further adjusted so as to contain 0.08% of a fluorescent brightening agent (Whiteflour PSN conc, manufactured by Nippon Chemical Industrial Co., Ltd.). Next, low density polyethylene having a MFR (melt flow rate) of 3.8 was melt-extruded using a melt-extruder in the thickness of 25 μm, and a thermoplastic resin layer having a glossy surface (hereinafter referred to as “front surface”) was formed on the frontside of the substrate paper, thereby preparing a support. The support thus obtained was formed as an elongated roll body having a transverse dimension of 1.5 m and a winding length of 3000 m.

Preparation of Coating Liquid A for ink receiving layer (First Liquid)

Fumed silica fine particles (1), ion exchange water (2), and “Shallol DC-902P” (3), and “ZA-30” (4) in the composition described below were mixed and the mixture was dispersed using a beads mill (for example, “KD-P” manufactured by Shinmaru Enterprises Corporation). Thereafter, the dispersion liquid was heated to 45° C. and kept for 20 hours. Subsequently, added to the mixture were a boric acid (5), a polyvinyl alcohol-dissolved solution (6), “Super Flex 600B” (7), polyoxyethylene lauryl ether (8), and an ethanol (9) at 30° C., thereby preparing the coating liquid A for an ink receiving layer (the first liquid).

Composition of Coating Liquid a for Ink Receiving Layer:

| | | |
|---|---|---|
| (1) | fumed silica fine particles | 10.0 parts |
| | (inorganic fine particles) | |
| | (AEROSIL 300SF75, manufactured | |
| | by Nippon Aerosil Co., Ltd.) | |
| (2) | ion exchange water | 64.8 parts |
| (3) | “Shallol DC-902P” | 0.87 parts |
| | (51.5% aqueous solution) | |
| | (dispersant manufactured by | |
| | Daiichi Kogyo Seiyaku Co., Ltd.) | |
| (4) | “ZA-30” (zirconium acetate) | 0.54 parts |
| (5) | boric acid (cross-linking agent) | 0.37 parts |
| (6) | polyvinyl alcohol (water-soluble | 29.4 parts |
| | resin) dissolved solution | |

(Composition of the Dissolved Solution:

| | | |
|---|---|---|
| *“PVA235” manufactured by Kuraray Co., Ltd., saponification value: 88%, | 2.03 | parts |
| degree of polymerization: 3500) | | |
| *polyoxyethylene lauryl ether (surfactant) | 0.03 | parts |
| *compound expressed by the following formula (1) | 0.06 | parts |
| *diethyleneglycol monobutyl ether (diethyleneglycol monobutyl ether-P, | 0.68 | parts |
| manufactured by Kyowa Hakko Co., Ltd.) | | |
| *ion exchange water | 26.6 | parts |
| (7) “Super Flex 600B” (produced by Daiichi Kogyo Seiyaku Co., Ltd.) | 1.24 | parts |
| (8) polyoxyehtylene lauryl ether (surfactant) (“Emulgen 109P” (10% aqueous | 0.49 | parts |
| solution), HLB value: 13.6 parts, produced by Kao Corp.) | | |
| (9) ethanol | 2.49 | parts |

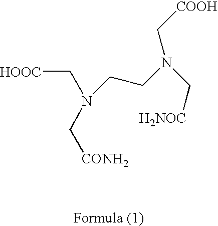

Production of Ink Jet Recording Sheet

The front surface of the support was subjected to corona discharge treatment, and thereafter, subjected to in-line coating with the first liquid in the coating amount of 173 ml/m² and a 1 to 5 diluted polychlorinated aluminum aqueous solution (in which polychlorinated aluminum is “Alfine 83” manufactured by Taimei Chemicals Co., Ltd.) at the rate of 10.8 ml/m². The coating layer was dried by a hot-air dryer 80° C. (wind velocity: 3 to 8 m/sec) until the solid density of the coating layer became 20%. During the drying step, the coating layer exhibited a constant rate of drying. Before exhibiting a decreasing rate of drying, the coating layer was dipped in a basic solution B (second liquid) having the following composition for 3 seconds, to cause the coating liquid to adhere to the coating layer in an amount of 13 g/m². After that, the coating liquid was dried at 80° C. for 10 minutes (step (B): hardening step). As a result, the ink jet recording medium of Example 1 with an ink receiving layer having a dried film thickness of 32 μm formed thereon was produced.

<Composition of Basic Solution B>

| | | |
|---|---|---|
| (1) | boric acid | 0.65 parts |
| (2) | ammonium zirconium carbonate (Zircozol | 2.5 parts |
| | AC-7 (a 28% aqueous solution) | |
| | manufactured by Daiichi Kigenso Kagaku | |
| | Kogyo Co., Ltd.) | |
| (3) | ammonium carbonate (primary one; | 3.5 parts |
| | manufactured by Kanto Kagaku Co.) | |
| (4) | ion exchange water | 63.3 parts |
| (5) | polyoxyethylene lauryl ether (surfactant) | 30.0 parts |
| | (“Emulgen109P” (a 2% aqueous | |
| | solution), HLB value: 13.6; manufactured | |
| | by Kao Corp.) | |

### Example 2

An ink jet recording medium of Example 2 was prepared as in Example 1, except that in-line coating with a 1 to 5 diluted polychlorinated aluminum aqueous solution was not performed.

### Example 3

An ink jet recording medium of Example 3 was prepared as in Example 1, except that “ZA-30” was not used in the first liquid.

### Example 4

An ink jet recording medium of Example 4 was prepared as in Example 2, except that “ZA-30” was not used in the first liquid, and 0.27 parts of magnesium chloride.6H₂O and 0.27 parts of aluminum sulfate were added.

### Comparative Example 1

An ink jet recording medium of Comparative Example 1 was prepared as in Example 2, except that the composition of the second liquid are changed as shown below.

<Composition of Second Liquid>

| | | |
|---|---|---|
| (1) | boric acid | 0.65 parts |
| (2) | aqueous 20% polyallylamine solution | 3.0 parts |
| | (PAA-03 manufactured by Nitto Boseki | |
| | Co., Ltd.; a mordant) | |
| (3) | p-toluenene sulfonic acid (manufactured | 1.8 parts |
| | by Kounan Kakou) | |
| (4) | ammonium chloride (manufactured by | 0.1 parts |
| | Central Glass Co., Ltd.) | |
| (5) | ion exchange water | 63.3 parts |
| (6) | polyoxyethylene lauryl ether (surfactant) | 10.0 parts |
| | (“Emulgen109P” (a 2% aqueous | |
| | solution, HLB value: 13.6; manufactured | |
| | by Kao Corp.) | |
| (7) | fluorinated surfactant (a 10% aqueous solution) | 0.2 parts |
| | (“MEGAFACE F1405 manufactured by | |
| | Dainippon Ink and Chemicals, Inc.) | |

### Comparative Example 3

An ink jet recording medium of Comparative Example 3 was prepared as in Example 1 except that “ZA-30” was not used in the first liquid and “Zircozol AC-7” was not used in the second liquid.

[Evaluation]

The ink jet recording media of Examples 1 to 4 and Comparative Examples 1 to 3 thus obtained were each subjected to the following evaluations. Evaluation results are shown in Table 1 shown below.

(1) Color Density

Using an ink jet printer (PM970C, manufactured by Seiko Epson), a solid image of yellow, magenta, cyan and black was printed on each ink jet recording medium and allowed to stand for 24 hours in an environment of 23° C. and 60% RH. Subsequently, the respective color densities of each ink jet recording medium were measured by a reflection densitometer (Xrite 938, manufactured by X-rite). The black density having a significant variation in the color density is shown in Table 1.

(2) Glossiness

Using an ink jet print (PM970C, manufactured by Seiko Epson), a solid image of black was printed on each ink jet recording medium. Subsequently, using a digital variable gloss meter (UGV-5D, manufactured by Suga Test Instruments Co., Ltd.; measurement hole: 8 mm), the glossiness of a solid image potion of black was measured at each of the incident angle of 45 degrees, light acceptance angles of 42, 45, and 48 degrees, and the glossiness was calculated by the expression shown below. If the glossiness value is less than 0.05, components of the light scattered and reflected from the recording sheet surface are reduced, and therefore, preferred glossiness as in a silver-salt photograph is obtained.
Glossiness=((42-degree glossiness+48-degree glossiness)/2)/(45-degree glossiness)
(3) Bleeding

Using the same printer as in the above evaluation (1) and (2), a grid-shaped linear pattern (line width: 0.28 mm) with a magenta ink and a black ink being located adjacently was printed on each ink jet recording medium. Directly after the printing, the printed ink jet recording medium was inserted in a transparent file made of polypropylene (PP), and allowed to stand for 3 days in an environment of 35° C. and 80% of relative humidity. Subsequently, the widthwise dimension of black lines in the linear pattern was measured, and the value of bleeding (%) over time was calculated from the measured value and the widthwise dimension of black lines directly after the printing, which was previously obtained.
Bleeding over time (%)=(width of black lines in the linear pattern kept for 3 days in the environment of 35° C. and 80%)/(width of black lines directly after printing)×100
(4) Bronzing

Using the same printer as the above, a solid image of dark blue was printed on each ink jet recording sheet and allowed to stand for one day. Subsequently, the degree of bronzing occurring was visually observed to evaluate according to the following standard.

Standard:

A: no bronzing occurred.

B: bronzing occurred.

TABLE 1

| | | | | | Comparative | Comparative | Comparative |
|---|---|---|---|---|---|---|---|
| | Example 1 | Example 2 | Example 3 | Example 4 | Example 1 | Example 2 | Example 3 |
| 1st liquid | ZA-30(Zr) | ZA-30(Zr) | PAC(Al) | magnesium | Magnesium | Magnesium | PAC(Al) |
| | | | | chloride | chloride | chloride | |
| | PAC(Al) | — | — | aluminum | Aluminum | — | — |
| | | | | sulfate | sulfite | | |
| 2nd liquid | AC-7(Zr) | AC-7(Zr) | AC-7(Zr) | AC-7(Zr) | PAA (no | PAA (no | no metal |
| | | | | | metal used) | metal used) | used |
| pH of 1st liquid | 3.8 | 3.8 | 3.4 | 3.5 | 3.5 | 3.6 | 3.4 |
| pH of 2nd liquid | 7.9 | 7.9 | 7.9 | 7.9 | 9.3 | 9.3 | 9.3 |
| pH of ink | 4.5 | 4.5 | 4.5 | 4.6 | 6.0 | 6.1 | 4.5 |
| receiving layer | | | | | | | |
| C1/C2 | 0.90 | 0.86 | 0.88 | 0.91 | 1.01 | 1.02 | 1.01 |
| color density | 2.42 | 2.43 | 2.45 | 2.40 | 2.35 | 2.35 | 2.0 |
| glossiness | 0.04 | 0.043 | 0.042 | 0.045 | 0.058 | 0.051 | 0.075 |
| bleeding | 131 | 147 | 142 | 148 | 154 | 157 | 161 |
| bronzing | A | A | A | A | B | B | A |

It is found from Table 1 that the ink jet recording media obtained in Examples 1 to 4 can each obtained desired results in color density, glossiness, bleeding and bronzing. However, in the ink jet recording media obtained in Comparative Examples 1 to 3, results in at least one of color density, glossiness, bleeding and bronzing are inferior.

According to the present invention, an ink jet recording medium in which excellent printing density and glossiness of an image is obtained and image bleeding over time is reduced, and a method for producing the same can be provided.

What is claimed is:

1. A method for producing an ink jet recording medium, in which an ink receiving layer is formed on a support, wherein the forming of the ink receiving layer comprises:
coating the support with a first liquid containing a water-soluble resin, a cross-linking agent and a first metal compound, to form a coating layer on the support; and
applying, to the coating layer, a second liquid containing a second metal compound (1) at the same time as the coating of the first liquid, or (2) before the coating layer formed by coating the first liquid exhibits a decreasing rate of drying during drying of the coating layer, to harden the coating layer by cross-linking.

2. The method of claim 1, wherein said second liquid further contains a basic compound.

3. The method of claim 1, wherein said first liquid further contains inorganic fine particles.

4. The method of claim 1, wherein said first liquid or said second liquid further contains a surfactant.

5. The method of claim 1, wherein said first liquid contains two or more types of the first metal compound.

6. The method of claim 1, wherein said first metal compound or said second metal compound is a zirconium compound or an aluminum compound.

7. The method of claim 2, wherein said basic compound is an ammonium salt of weak acid.

8. The method of claim 1, wherein said water-soluble resin is polyvinyl alcohol.

9. The method of claim 1, wherein said cross-linking agent is a boron compound.

10. The method of claim 1, wherein said first liquid has a pH of 6.0 or less, and said second liquid has a pH of 7.1 or more.

11. An ink jet recording medium produced by the method of claim 1, wherein all types of metal compounds in the ink receiving layer are distributed more extensively in a direction away from the support.

12. The ink jet recording medium of claim 11, wherein said ink receiving layer has a pH of 3 to 6.

13. The ink jet recording medium of claim 11, wherein said second liquid further contains a basic compound.

14. The ink jet recording medium of claim 11, wherein said first liquid further contains inorganic fine particles.

15. The ink jet recording medium of claim 11, wherein said first metal compound or said second metal compound is a zirconium compound or an aluminum compound.

16. An ink jet recording medium produced by the method of claim 1, wherein a ratio of concentration of all types of metal compounds in the ink receiving layer satisfies the following expression:
0.8<C1/C2<1.0
wherein C1 and C2 respectively represent a relative concentration of the metal compounds in a layer that contacts the support and in a layer that does not contact the support when the ink receiving layer is divided into two equal parts by a cross section parallel to the support.

17. The ink jet recording medium of claim 16, wherein the ink receiving layer has a pH of 3 to 6.

18. The ink jet recording medium of claim 16, wherein said second liquid further contains a basic compound.

19. The ink jet recording medium of claim 16, wherein said first liquid further contains inorganic fine particles.

20. The ink jet recording medium of claim 16, wherein said first metal compound or said second metal compound is a zirconium compound or an aluminum compound.
